(19) United States
(12) Patent Application Publication
(10) Pub. No.: US 2023/0243663 A1
(43) Pub. Date: Aug. 3, 2023

(54) METHODS FOR DETERMINING AN EMISSION SAVINGS VALUE

(71) Applicant: Carbon Chit Inc., Calgary (CA)

(72) Inventor: Ivan BEENTJES, Calgary (CA)

(21) Appl. No.: 18/148,015

(22) Filed: Dec. 29, 2022

Related U.S. Application Data
(60) Provisional application No. 63/304,243, filed on Jan. 28, 2022.

(51) Int. Cl. G01C 21/34; G01C 21/00

(52) U.S. Cl. CPC G01C 21/3469; G01C 21/3848

(57) ABSTRACT

Methods for determining an emission savings value are provided. In some embodiments, the method comprises: receiving, from a user device: a request for verification of a trip, the request indicating a mode of transport; location data collected during the trip; and sensor data collected by at least one sensor during the trip; determining a trip distance using the location data; attempting to verify the mode of transport by determining whether the sensor data corresponds to stored sensor data for the mode of transport in a database; and upon successful verification of the mode of transport, determining an emission savings value for the trip. In some embodiments, the method further comprises verifying a baseline mode of transport for the user.

### RELATED APPLICATION

The present application claims priority to U.S. Provisional Patent Application No. 63/304,243 filed Jan. 28, 2022, the entire contents of which are incorporated herein by reference.

### TECHNICAL FIELD

The present disclosure relates to environmental incentives. More particularly, the present disclosure relates to methods for determining emission savings values.

### BACKGROUND

The reduction and mitigation of greenhouse gas (GHG) emissions is increasingly critical to combat global warming and climate change. Carbon credit or offset programs can be used to incentivize the reduction of GHG emissions by providing tradeable offsets that can be bought and sold in a common carbon marketplace. Parties that participate in emission-reducing activities can sell their carbon credits to parties engaged in emission-generating activities, allowing the latter to offset their total emissions.

One activity that can be used as the basis for issuing carbon credits is transportation. In many parts of the world, personal vehicles are the standard form of transportation for individuals. However, vehicles that use fossil fuels generate substantial GHG emissions. Carbon credits can be used to incentivize modes of transport with lower (or no) GHG emissions such as electric or hybrid vehicles, taking public transportation, biking, walking, etc.

Carbon credit systems have been proposed where credits are issued to a user who uses a mode of transportation with lower emissions than a baseline vehicle. The total number of carbon credits may be calculated based on the difference in carbon emissions between the two modes of transportation and distance traveled. However, such systems may have challenges with users “cheating” by claiming they used a different mode of transport than they really used or by exaggerating their total distance traveled. As a result, the calculated carbon credits may require extensive verification, often by an independent system, before being issued to the user. Such verification may be inefficient and require substantial computer processing power. In addition, the independent system may not be able to catch all instances of “cheating” due to a lack of corroborating data.

Carbon credits must pass the test of ‘additionality’; which means the carbon emissions reduction would not have occurred without the monetary incentive of a carbon credit. The proof of additionality necessarily increases the rigor required of a carbon credit quantification mechanism.

### SUMMARY

In one aspect, there is provided a computer-implemented method comprising: receiving, from a user device: a request for verification of a trip, the request indicating a mode of transport; location data collected during the trip; and sensor data collected by at least one sensor during the trip; determining a trip distance using the location data; attempting to verify the mode of transport by determining whether the sensor data corresponds to stored sensor data for the mode of transport in a database; and upon successful verification of the mode of transport, determining an emission savings value for the trip.

In some embodiments, the sensor data comprises at least one of: photographic data, video data, accelerometer data, vibration data, sound signature data, and altitude data.

In some embodiments, the location data comprises at least one of GPS logs, cell phone pings and cell tower triangulation, cell signal strength data, mapping software data, and compass data.

In some embodiments, determining the trip distance comprises determining displacement of the user between a start location and an end location using location data from a start point and an end point of the trip.

In some embodiments, attempting to verify the mode of transport further comprises: determining a predicted travel time for the trip based on historical data for the mode of transport; receiving an actual travel time for the trip from the user device; and determining whether the actual travel time corresponds to the predicted travel time.

In some embodiments, attempting to verify the mode of transport further comprises: determining a travel speed based on the actual travel time and the trip distance; and determining whether the travel speed is possible for the mode of transport.

In some embodiments, attempting to verify the mode of transport further comprises identifying a vehicle via a connection between the vehicle and the user device.

In some embodiments, determining the trip distance comprises determining an actual distance travelled by the user using the location data from various points during the trip.

In some embodiments, the method further comprises: determining a shortest reasonable distance for the trip using a mapping data source; determining whether the actual distance is longer than the shortest reasonable distance; upon determining that the actual distance is longer than the shortest reasonable distance, using the shortest reasonable distance to determine the emission savings value for the trip.

In some embodiments, determining the emission savings value for the trip comprises determining a difference between an emission estimate for the trip and a baseline emission estimate for a baseline mode of transport.

In some embodiments, the method further comprises attempting to verify the baseline mode of transport.

In some embodiments, the baseline mode of transport is a vehicle and wherein attempting to verify the baseline mode of transport comprises at least one of: determining if the vehicle is registered to the user; and determining if the vehicle is covered by an active insurance policy for at least part of the trip.

In some embodiments, attempting to verify the baseline mode of transport further comprises comparing an emissions reduction claimed by the user with a per vehicle normalized average emissions reduction for a geographical area.

In some embodiments, the method further comprises: receiving, from the user device, user input indicating at least one additional passenger using the same mode of transport; attempting to pair the user device with at least one passenger device; and upon successful pairing, allocating the emission savings value between the user and the at least one additional passenger.

In another aspect, there is provided a computer-implemented method comprising: receiving, from a user device, user input identifying a baseline vehicle, the user input including at least one of a user name, a vehicle identification number (VIN), and an insurance policy number; attempting to verify the baseline vehicle by at least one of: determining if the VIN corresponds with a stored VIN associated with the user in a vehicle registration database; transmitting a request for confirmation of registration to an external vehicle registry, the request for confirmation indicating at least one of the user name and the VIN; determining if the insurance policy number corresponds with a stored active insurance policy number associated with the user in an insurance policy database; and transmitting a request for confirmation of an active insurance policy to an external insurance provider, the request indicating at least one of the user name, the VIN, and the insurance policy number; upon successful verification of the baseline vehicle, receiving, from the user device a request for verification of a trip, the request for verification indicating a mode of transport; and determining an emission savings value based on a difference in estimated emissions between the mode of transport and the baseline vehicle for the trip.

In some embodiments, attempting to verify the baseline vehicle comprises transmitting the request for confirmation of the active insurance policy to the external insurance provider, and further comprises receiving a response from the external insurance provider, the response including the VIN of the baseline vehicle.

In some embodiments, the method further comprises comparing an emissions reduction claimed by the user with a per vehicle normalized average emissions reduction for a geographical area.

In some embodiments, the method further comprises receiving, from the user device, location data collected during the trip; and determining a trip distance using the location data.

In some embodiments, the method further comprises receiving, from the user device, sensor data collected by at least one sensor during the trip; and attempting to verify the mode of transport by determining whether the sensor data corresponds to stored sensor data for the mode of transport in a database.

In some embodiments, the method further comprises receiving, from the user device, user input indicating at least one additional passenger using the same mode of transport; attempting to pair the user device with at least one passenger device; and upon successful pairing, allocating the emission savings value between the user and the at least one additional passenger.

Other aspects and features of the present disclosure will become apparent, to those ordinarily skilled in the art, upon review of the following description of specific embodiments of the disclosure.

### BRIEF DESCRIPTION OF THE DRAWINGS

Some aspects of the disclosure will now be described in greater detail with reference to the accompanying drawings. In the drawings:

FIG. 1 is a schematic of a system for implementing embodiments of the methods disclosed herein, according to some embodiments;

FIG. 2 is a block diagram of a server of the system of FIG. 1;

FIG. 3 is a block diagram of a user device of the system of FIG. 1;

FIG. 4 is a flowchart of an example method for determining an emission savings value, according to some embodiments;

FIG. 5 is a flowchart of another example method with additional steps for verifying a mode of transport, according to some embodiments;

FIG. 6 is a flowchart of another example method with additional steps for verifying the mode of transport, according to some embodiments;

FIG. 7 is a flowchart of an example method for verifying a baseline mode of transport, according to some embodiments;

FIG. 8 is a flowchart of an example method with additional steps for determining the emission savings value, according to some embodiments; and

FIG. 9 is a flowchart of an example method with additional steps for verifying a multi-user trip.

### DETAILED DESCRIPTION

Generally, the present disclosure provides computer-implemented methods for determining an emission savings value. In some embodiments, the method comprises: receiving, from a user device, via a communication network: a request for verification of a trip, the request indicating a mode of transport; location data collected during the trip; and sensor data collected by at least one sensor during the trip; determining a trip distance using the location data; attempting to verify the mode of transport by determining whether the sensor data corresponds to stored sensor data for the mode of transport in a database; and upon successful verification of the mode of transport, determining an emission savings value for the trip. In some embodiments, the method further comprises verifying a baseline mode of transport for the user.

As used herein the terms “a”, “an,” and “the” may include plural referents unless the context clearly dictates otherwise.

As used herein, an “emission savings value” refers to a value that quantifies a reduction or mitigation of greenhouse gas (GHG) emissions and is inclusive of carbon credits, carbon offsets, and any other unit used for regulating and/or incentivizing the reduction of GHG emissions.

As used herein, “user” refers to any entity, individual, or group that is utilizing (partially or completely) a computer implemented system for calculating carbon emissions reductions. The user may request verification of the trip via a mobile application installed on a user device.

As used herein, a “trip” refers to travel of a user between a start point and an end point. The “start point” of the trip is a point in time at which the user starts the trip i.e., the point in time at which the user starts to travel using a given mode of transport. The geographical location of the user at the start point of the trip is referred to as the “start location” or “first location” herein. The “end point” of the trip is a point in time at which the user ends the trip i.e., the point in time at which the user stops traveling (at least temporarily) using the given mode of transport. The end point may be the final destination of the user or may be any specific point at which the user wishes to request verification of the trip. The geographical location of the user at the end point of the trip is referred to as the “end location” or “second location” herein.

In some embodiments, one or both of the start point and end point of the trip are identified manually via user input. For example, the start point of the trip may be when the user indicates in the mobile application that they are starting a trip and the end point may be when the user stops the trip via the mobile application. In other embodiments, the start and/or end points may be automatically identified by the mobile application. For example, the mobile application may have a pre-set proximity around the user's home and workplace (and/or other common locations) and may identify the start point of the trip automatically as when as the user leaves the proximity of their home and the end point when the user enters the proximity of their workplace (or vice versa). Alternatively, the mobile application may access sensors in the user device to determine when the user starts and stops traveling. For example, accelerometer data, sound data, or data from the vehicle's onboard computer could be used to determine when the user starts and stops driving their vehicle.

As used herein, a “mode of transport” or “mode of transportation” are used interchangeably herein to refer to any mode of transport that can be used by a user for a trip. The mode of transport may be motorized or non-motorized. Motorized modes of transport include vehicles such as motor vehicles, motorized bicycles, motorized scooters, railed vehicles, aircraft, and motorized watercraft. Non-limiting examples of motor vehicles include cars, trucks, buses, vans and other fleet vehicles, sedans, sports utility vehicles (SUVs), off-road vehicles, three-wheelers, and motorcycles. Railed vehicles may include trains, trams, subways, and light rail transport. Aircraft may include commercial or private planes. Motorized watercraft may include ships, boats, and underwater vehicles. Vehicles may be powered by an internal combustion engine (hereafter a “combustion engine vehicle”), an electric motor (hereafter an “electric vehicle”) or a combination of the two (hereafter a “hybrid vehicle”). The vehicle may be a personal vehicle (i.e., only used by the user and individuals authorized by the user) or a form of public transit (used by any member of the public).

Non-motorized modes of transport include human-powered modes of transport such as walking, running, biking (with a non-motorized bicycle), skating (with ice skates or roller skates), roller-blading, using a non-motorized scooter, using a rowboat, kayak, etc. In other embodiments, the non-motorized mode of transport may be horseback riding or any other animal-based mode of transport. In yet other embodiments, the mode of transport may be any other mode of transport and embodiments are not limited to only the specific modes disclosed herein.

In some embodiments, the mode of transport is a “zero-combustion emissions” mode of transport, that is, a mode of transport that does not use combustion of fuel and, therefore, does not generate carbon emissions during transport. It will be understood however that a zero-combustion emissions mode of transport may still indirectly generate carbon emissions, for example, in generation of the power used to charge an electric vehicle, bike, etc. Fully electric vehicles and human-powered modes of transport such as walking or biking are examples of zero-combustion emissions modes of transport.

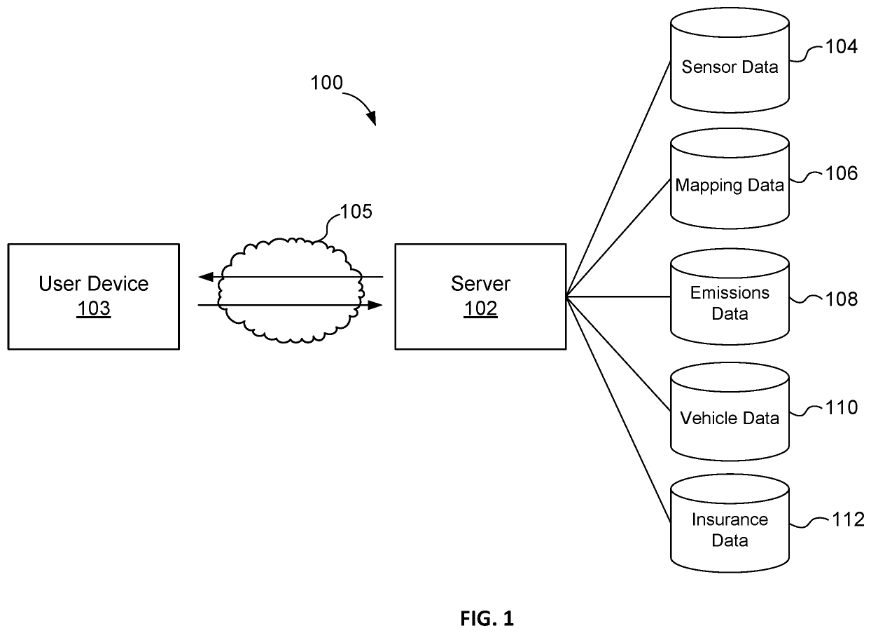

FIG. 1 is a schematic of an example system 100 that may implement one or more of the methods disclosed herein.

The system 100 comprises a server 102 operable to communicate with a user device 103 over one or more communication networks 105. As used herein “server” refers to any network equipment comprising circuitry, hardware, and/or software for performing the functions described herein. As used herein, “user device” refers to any device capable of communication over a wireless network including, but not limited to, mobile communication devices such as mobile phones, smart phones, tablets, smart watches, and activity tracking devices, as well as hardware installed on a vehicle such as a vehicle's onboard computer. In some embodiments, the “user device” is a combination of devices, such as the combination of the user's smart phone and the user's vehicle, which together provide the functions of the user device 103.

Moreover, although certain functions are described herein as being performed by the server 102, it will be understood that any of the functions performed by the server 102 may alternatively be performed by the user device 103. In other embodiments, the server 102 may be omitted entirely and all of the functions ascribed to the server 102 are performed by the user device 103.

The system 100 may further comprise one or more data sources. In this embodiment, the system 100 further comprises a sensor data source 104, a mapping data source 106, and an emissions data source 108. Optionally, the system 100 may further comprise a vehicle data source 110 and an insurance data source 112. Each of the sensor data source 104, mapping data source 106, emissions data source 108, vehicle data source 110 and insurance data source 112 may comprise one or more servers and/or databases that store programs and/or data that are accessible to the server 102.

The sensor data source 104 may comprise one or more databases storing data associated with any of the modes of transport described above. The phrase “associated with” in in this context refers to data that identifies or otherwise indicates a given mode of transport, data previously generated from that mode of transport, predicted or simulated data for that mode of transport, or any other data related to that mode of transport. The stored data may include photographic data, image data, video data, accelerometer data, vibration data, sound signature data, altitude data, and/or any other data relevant to discriminating a given mode of transport. The sensor data source 104 further comprises location data collected either directly from the user device 103 or from a global positioning system (GPS) or from communications with cellular network towers.

The mapping data source 106 may comprise programs and data for mapping a trip route, The mapping data source 106 may include mapping software (e.g., Google Maps, Apple Maps, open source code, etc.), public transit trip planning software, ride share or taxi trip planning software, and/or any other program capable of mapping a trip route.

The emissions data source 108 may comprise one or more databases that store GHG emission data for different modes of transport. The GHG emission data may include, for example, testing data, data from comparable vehicles, verified and unverified emissions data, and historical trips including duration, location, and behaviors. The emissions data source 108 may store one or more emission profiles for each mode of transport based on the GHG emission data. For combustion engine and hybrid vehicles, the emission profile may include a range of fuel efficiencies for a vehicle. For electric vehicles, the emission profile may account for the emissions associated with how the power used for charging the vehicle is generated. In some embodiments, a given vehicle may have a different emission profile for different geographical areas, climates, seasons, or weather. The emissions data source 108 may also store information regarding baseline modes of transport. As used herein, “baseline mode of transport” refers to a reference mode of transport against which emissions savings values are calculated. The emissions data source 108 may also store localized average emission savings values for different modes of transport compared to baseline modes of transport in a geographical area. The emissions data source 108 may also generate unique deterministic or non-deterministic outputs when called upon by the server 102. For example, the emission profile for a given mode of transport may be based on a model that is updated as new data becomes available, resulting in different output (e.g., different emissions information) at different times in response to the same input (e.g., the same mode of transport). In some embodiments, the new data can include real time data inputs (e.g., weather conditions) that change the outputs.

The vehicle data source 110 may store data relating to user vehicles. In some embodiments, the vehicle data source 110 comprises a vehicle registration database in which vehicle identification numbers (VINs) are associated with user ownership details. The insurance data source 112 may store data relating to vehicle insurance policies. In some embodiments, the insurance data source 112 comprises an insurance policy database in which insurance policies are associated with user vehicles. In this embodiment, the vehicle data source 110 and the insurance data source 112 are both part of the system 100; however, in other embodiments, at least one of the vehicle data source 110 and the insurance data source 112 is part of an independent system in communication with the system 100 via the communication network 105. For example, the vehicle data source 110 may be an external vehicle registry with its own vehicle registration database. The insurance data source 112 may be an external insurance provider its own insurance policy database. The server 102 may communicate with the external registry and/or insurance provider using the same network with which the server 102 communicates with the user device 103 or a different network.

Although the sensor data source 104, mapping data source 106, emissions data source 108, the vehicle data source 110 and the insurance data source 112 are all shown as separate data sources in FIG. 1, it will be understood that two or more of the data sources be included in or implemented by the same database or server. For example, the sensor data source 104, mapping data source 106, the vehicle data source 110 and the insurance data source 112 may all be internal to, or combined with, the emissions data source 108.

In some embodiments, the system 100 further comprises a database or a subset in a database such as an array (not shown) that stores user profiles. Each user profile may include a baseline mode of transport associated with the user and any other relevant information such as alternative modes of transport previously used by the user, historical trips and emission savings values, etc. Alternatively, or additionally, the user profile may include a user consumption baseline. As used herein, “user consumption baseline” refers to a reference level of fuel consumption for a given user based on their past activities.

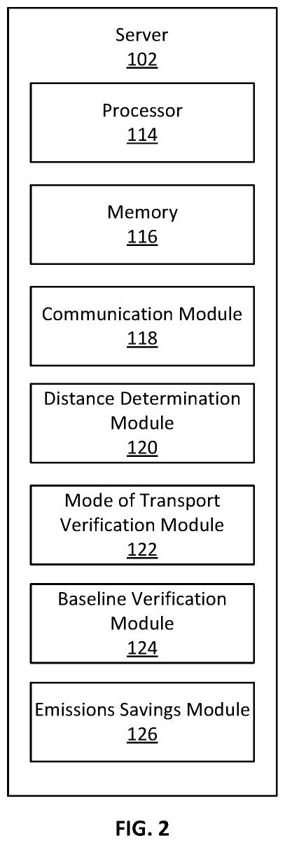

The server 102 will be described in more detail with reference to FIG. 2. The server 102 in this embodiment comprises at least one processor 114, a memory 116, a communication module 118, a distance determination module 120, a mode of transport verification module 122, a baseline verification module 124, and an emissions savings module 126.

The memory 116 is operatively connected to the processor 114. The memory 116 may store processor-executable instructions therein that, when executed, cause the processor 114 to implement one or more methods described herein.

The communication module 118 may comprise one or more transceivers. configured to send and receive communications over one or more communication networks 105 such as the Internet. In some embodiments, the communication network 105 may comprise a secure network. The communication network 105 may comprise a wired or a wireless network. The wireless network may comprise a mobile device communication network, a satellite communication network, a local area network (LAN) such as Wi-Fi and/or any other suitable wireless network. In some embodiments, the transceiver comprises both a transmitter and a receiver sharing common circuitry. In other embodiments, the transceiver comprises a separate transmitter and receiver. The communication module 118 allows the server 102 to receive data from the user device 103 and transmit instructions and information thereto.

The distance determination module 120 may be configured to determine a trip distance using location data collected by the user device 103 or from GPS or communication with cellular network towers. The distance determination module 120 may use the location data to determine displacement of the user between a start location and an end location. The distance determination module 120 may also determine the actual distance travelled by the user based on location data collected at various points throughout the trip. In some embodiments, the distance determination module 120 also determines a shortest reasonable distance for the trip using the mapping data source 106 and compares the actual distance travelled by the user to the shortest reasonable distance, as described in more detail below.

The mode of transport (MoT) verification module 122 may be configured to verify a mode of transport inputted by a user and/or received in a trip verification request from the user device 103. In some embodiments, the MoT verification module 122 verifies the mode of transport by determining whether sensor data from the user device 103 corresponds to stored sensor data in the sensor data source 104. The MoT verification module 122 may also verify the MoT by determining a predicted travel time for the trip based on the mode of transport and comparing the predicted travel time with an actual travel time received from the user device 103. The MoT verification module 122 may also determine whether the minimum and/or maximum travel speed for the mode of transport is possible or realistic for that mode of transport.

The baseline verification module 124 may be configured to verify a baseline mode of transport for the user. For example, the baseline mode of transport may be the user's primary vehicle and the baseline verification module 124 may determine whether that vehicle is registered to the user using data from the vehicle data source 110 and/or whether the vehicle is associated with an active insurance policy using data from the insurance data source 112. The baseline verification module 124 may also determine if the vehicle claimed by the user is reasonable compared to their peers using data in the emission data source 108.

Optionally, the server 102 may further comprise a user consumption module (not shown) configured to determine a user consumption baseline for the user. In some embodiments, the user consumption module determines the user consumption baseline based on the user's fuel consumption over a specific period of time. For example, the user may grant permission to the server 102, via the user device 103, to access their bank account and/or credit card records and the user consumption module may determine the user consumption baseline based on fuel purchases over the previous 6 months, or 1 year, etc. In other embodiments, the user may upload gas receipts for a specific period of time to allow the user consumption module to determine a baseline. In yet other embodiments, the user consumption module may determine the baseline using vehicle sensor data or odometer readings, as discussed in more detail below.

In alternative embodiments, the baseline verification module 124 may be omitted from the server 102 and replaced with the user consumption module.

The emissions savings module 126 may be configured to determine an emissions savings value for the trip. For example, the emission savings module 126 may determine an emission estimate for the trip based on the user's mode of transport and then calculate the difference between the emission estimate and a baseline emission estimate for the trip using the baseline mode of transport (and/or using the user consumption baseline). The trip emission estimate may be determined using outputs from the MoT verification module 122 and the baseline emission estimate may be determined using outputs from the baseline verification module 124 and data and/or emission profiles stored in the emission data source 108. The emission savings module 126 may also return information on the user's baseline vehicle and the emission savings value for that trip to the emissions data source 108 to iteratively improve the quality of the data.

Each of the distance determination module 120, the MoT verification module 122, the baseline verification module 124, the optional user consumption module, and the emission savings module 126 may be implemented as a processor (such as the processor 114) configured to perform the functions described above. Each module may be implemented as a memory (such as the memory 116) containing instructions for execution by a processor (such as the processor 114), by hardware, or by a combination of instructions stored in a memory and additional hardware, to name a few examples. The memory 116 may be internal or external to the processor 114.

In this embodiment, the distance determination module 120, the MoT verification module 122, the baseline verification module 124, the user consumption module, and the emission savings module 126 are all part of the server 102. In other embodiments, one or more modules may be part of the user device 103 or a separate server in communication with the system 100 via one or more communication networks 105. For example, in other embodiments, the distance determination module 120 and the mode of transport verification module 122 may be part of the user device 103, while the baseline verification module 124, the user consumption module, and the emission savings module 126 are part of the server 102. As another example, in other embodiments, the distance determination module 120, the MoT verification module 122, and the baseline verification module 124 may be part of the server 102, while the emission savings module 126 may be part of a separate server that receives verified trip information from the server 102 and determines the emissions savings value therefrom.

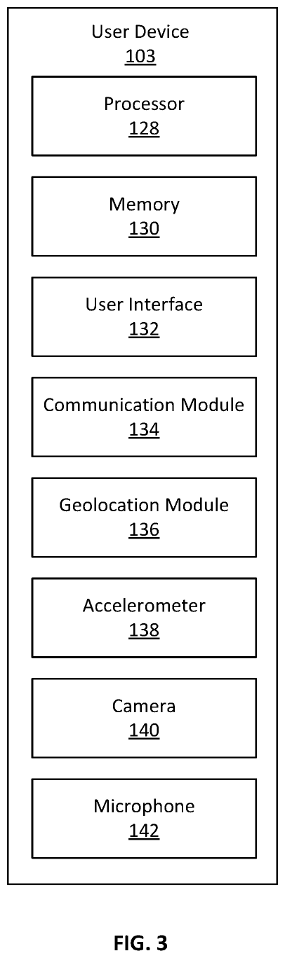

The user device 103 will be discussed in more detail with reference to FIG. 3. The user device 103 in this embodiment comprises a processor 128, a memory 130, a user interface 132, a communication module 134, and one or more sensors.

The memory 130 is operatively connected to the processor 128. The memory 130 may store processor-executable instructions therein that, when executed, cause the processor 128 to implement one or more methods described herein. In some embodiments, a mobile application is stored in the memory 130 including processor-executable instructions for submitting a request for a verification of a trip and communicating trip data to the server 102 via the communication network 105. In some embodiments, the user may be prompted to enable monitoring through the mobile application to allow the user device 103 to collect location data and sensor data during a trip. The mobile application may also include instructions for notifying the user, via the user interface 132, if the trip has been verified (or not) and the determined emission savings value.

The user interface 132 is configured to display information to the user and receive user input. The user interface may comprise at least one input component and at least one output component. The input component may comprise, for example, at least one of a touchscreen, a keyboard, a keypad, a mouse, a trackball, a stylus, a navigation pad, a voice input device, or any other suitable type of input device. The output component may comprise, for example, at least one of a display screen, a projector, a voice output device, or any others suitable type of output device. In some embodiments, the user interface 132 comprises a combined display and input component, such as a touchscreen. In other embodiments, such as when the user device 103 is an onboard computer of the user's vehicle, the user interface 132 may be omitted and the user device 103 may communicate automatically with the server 102 without user input (or with minimal user input).

The communication module 134 may be configured for both short-range communication and long-range communication. For short-range communication, the communication module 134 may comprise, for example, a Bluetooth transceiver. In some embodiments, the transceiver comprises both a transmitter and a receiver sharing common circuitry. In other embodiments, the transceiver comprises a separate transmitter and receiver. For long range communications, the communications module 134 may comprise a transceiver configured to send and receive communications over a communication network such as the Internet. The long-range transceiver may communicate over any of the networks described above for communication module 118 of the server 102. In some embodiments, the communication module 134 is also configured to connect, e.g., pair, with other user devices, as described in more detail below.

The geolocation module 136 is configured to collect location data for the user device 103 during a trip. The geolocation module 136 may include one or more location sensors such as a Global Positioning System (GPS) receiver. The location data may comprise GPS logs, cell phone pings and cell tower triangulation, cell signal strength data, mapping software data, compass data, or any other suitable data indicative of the location of the user device 103 at a given time. The location data may be collected at the start point and the end point of the trip. In some embodiments, the location data is also collected at discrete points during the trip or continuously throughout the trip. The location data collected by the geolocation module 136 may be stored in the memory 130 and/or passed directly to server 102.

The user device 103 comprises one or more sensors configured to collect sensor data during a trip. In this embodiment, the user device 103 comprises an accelerometer 138 (to measure movement of the user device 103), a camera 140 (to take photographs and/or videos), and a microphone 142 (to detect sounds). In some embodiments, the user device 103 further comprises one or more of: a gyroscope, a magnetometer, a barometer, a proximity sensor, a light sensor, and any other suitable sensor. The sensor data may be collected at any point during the trip or continuously throughout the trip. The sensor data may be stored in the memory 130.

In some embodiments, user device 103 is a single device, (e.g., a smart phone) and the geolocation module 136 and sensors (e.g., accelerometer 138, camera 140, and microphone 142) are all part of the same device. In other embodiments, the user device 103 is a combination of devices, such as the user's smart phone and the user's vehicle, and each device may provide one or more of the sensors and/or the geolocation module 136. For example, the geolocation module 136 and/or one or more sensors may be part of the user's vehicle and location data and/or sensor data may be transmitted from the vehicle to the user's smart phone. In other embodiments, location data and/or sensor data from the vehicle may be sent directly from the vehicle to the server 102. Non-limiting examples of vehicle sensors include at least one: GPS receiver, accelerometer, LIDAR, fuel tank sensor, microphone or other device for collecting sound data, odometer, speed/mileage sensor, temperature sensor, altitude sensor, ultrasonic sensor, radar device, camera, etc.

In yet other embodiments, one or more of the sensors may be an external sensor in communication with the user device 103 via the communication network 105. For example, one of the sensors may be a dash camera installed on the user's vehicle that transmits video and/or image data to the user device 103. It will be understood that reference to the “user device” herein is inclusive of these external sensors.

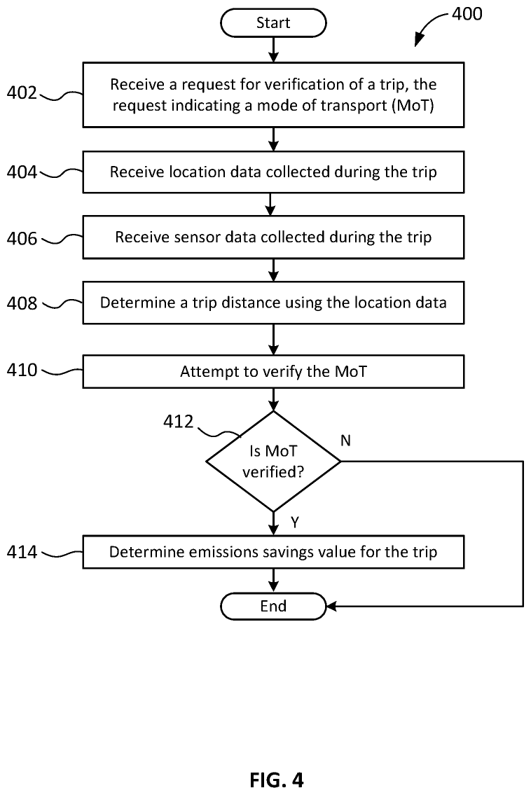

FIG. 4 is a flowchart of an example method 400 for determining an emission savings value for a trip, according to some embodiments. The method 400 may be implemented by the system 100 of FIG. 1.

Prior to the steps of the method 400, a user may install the mobile application on their user device 103 and the server 102 may generate a user profile for the user. The user may enable active monitoring via the mobile application prior to taking the trip. The user may then indicate in the mobile application that they are starting a trip. Alternatively, the mobile application may automatically identify a start point for the trip as discussed above.

At block 402, the server 102 receives a request for verification of the trip from the user device 103 via the communication network 105. The request may indicate a mode of transport (MoT). In some embodiments, the verification request is received from user input via the user interface 132. In other embodiments, the verification request is automatically generated by the mobile application, for example, when the user reaches a pre-determined end point as discussed above.

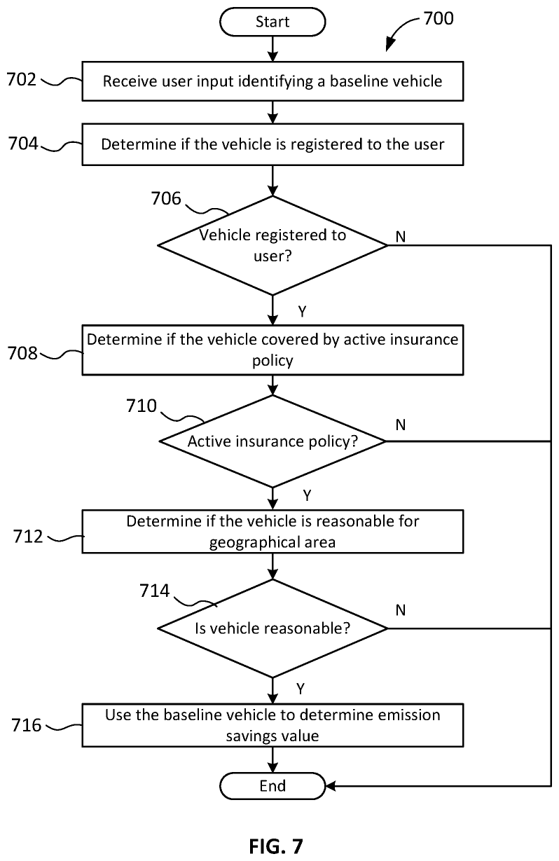

In some embodiments, the verification request also indicates a baseline mode of transport. For example, the verification request may identify the user's primary vehicle. The user-identified baseline mode of transport may be verified using the method of FIG. 7, described in more detail below. In other embodiments, the server 102 may retrieve a user profile for the user from the user database, or database subset, in which the user's baseline mode of transport is saved.

In some embodiments, the request is received at the end of the trip, after the trip has been completed. In other embodiments, the request is received at the start of a trip, or part way through a trip, with or without a projected end point. In some embodiments, requests are automatically sent from the user device 103 at predetermined points during the trip.

At block 404, the server 102 receives location data for the trip from the user device 103 via the communication network 105. The location data may indicate the geographical location of the user device 103 for at least the start point and the end point of the trip (i.e., the start location and end location of the trip). For example, the location data may comprise GPS logs or cell phone pings with cell tower triangulation for the user device 103 at the start point and the end point of the trip. In some embodiments, the location data may also indicate the location of the user device 103 at discrete times throughout the trip or for approximately the entire trip. For example, the location data may comprise the entire trip route tracked by a mapping software application such as Google Maps.

In some embodiments, the server 102 receives the location data at the end of the trip. In other embodiments, the server 102 receives the location data at one or more points during the trip or continuously throughout the trip in real-time. In some embodiments, the location data is received as part of the verification request. In other embodiments, the server 102 transmits a request to the user device 103 and receives the location data in response to the request. The server 102 may transmit the request responsive to the verification request received at block 402.

At block 406, the server 102 receives sensor data collected during the trip from the user device 103 via the communication network 105. The sensor data may comprise one or more of: accelerometer data, photographs, video, sound signature data, GPS data, vibration data, altitude data, and/or any other suitable sensor data. The sensor data may be for all or part of the trip.

In some embodiments, the server 102 receives the sensor data at the end of the trip. In other embodiments, the server 102 receives the sensor data at one or more points during the trip or continuously throughout the trip in real-time. In some embodiments, the sensor data is received as part of the verification request. In other embodiments, the server 102 transmits a request to the user device 103 and receives the sensor data in response to the request. The server 102 may transmit the request responsive to the verification request received at block 402.

In the example method 400 in FIG. 4, the sensor data is received after the location data; however, in other embodiments, the sensor data is received prior to receiving the location data or at substantially the same time.

At block 408, the server 102 determines a trip distance using the location data. The trip distance may be a displacement distance or an actual distance travelled by the user during the trip. The term “displacement distance” in this context refers to the distance measured in a straight line between the start location and the end location of the trip, regardless of the route actually travelled by the user from the start to end location. The term “actual distance” refers to the distance travelled by the user along their entire route of travel between the start location and the end location.

In some embodiments, the server 102 determines the displacement distance of the user using the location data. For example, the server 102 may determine the displacement distance of the user as a function of GPS logs or cell tower pings from the start and end locations of the trip.

Alternatively, (or additionally) the server 102 determines the actual distance travelled by the user using the location data. For example, the server 102 may determine the actual distance travelled as a function of GPS logs or cell tower pings from various points throughout the trip. In some embodiments, the server 102 may determine the actual distance travelled using data from a mapping software application.

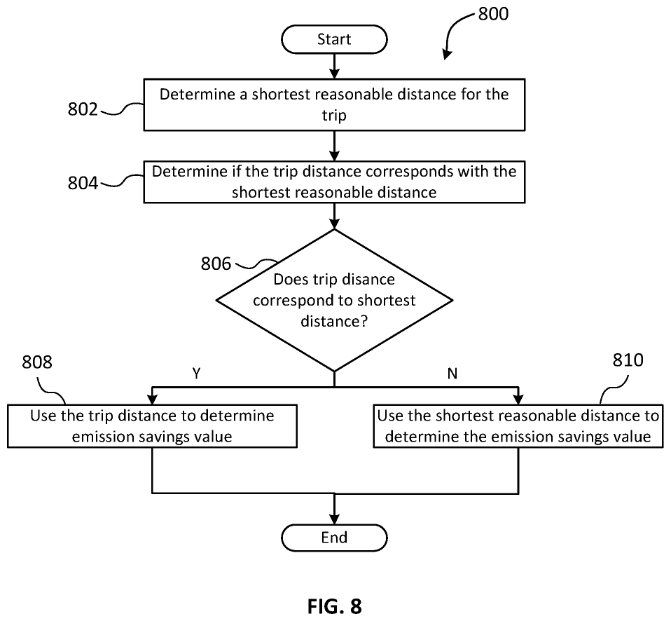

If location data is only available at the start and end points of the trip, then only the displacement distance will be determined and the displacement distance will be used in the emission savings value calculations at block 414 below. If location data is available for a sufficient number of points throughout the trip, then the actual distance travelled by the user may be determined and used in the emission savings value calculations. In some embodiments, the “shortest reasonable distance” may be used in place of the actual distance travelled, as discussed in more detail below with reference to FIG. 8. If there is insufficient location data to determine at least the displacement distance of the user (e.g., if there is no location data for the start or end location of the trip), the method 400 ends without determining the emission savings value.

At block 410, the server 102 attempts to verify the mode of transport. The server 102 may attempt to verify the mode of transport by determining whether the sensor data corresponds to stored sensor data in a database of the sensor data source 104 for that mode of transport. As one example, the server 102 may determine whether accelerometer data from the user device 103 corresponds with stored accelerometer data in the sensor data source 104. The accelerometer data for walking, biking, etc. may be significantly different than for a vehicle. As another example, the server 102 may determine whether one or more photos and/or videos taken during the trip correspond to photos and/or video in the sensor data source 104. The photos/videos may show if the user is in a vehicle or on foot, on a bike, etc. If the user is in a vehicle, the server 102 may verify the type of vehicle by comparison to photos/videos of various vehicle types in the sensor data source 104. As another example, sound data collected by the microphone, such as engine sounds, sounds of train or bus stops, etc. may be compared to sound profiles in the sensor data source 104. As yet another example, altitude data may be used to verify that the mode of transport is an aircraft. In some embodiments, multiple types of sensor data are collected and compared with stored sensor data, thereby increasing the accuracy of the verification step.

As discussed above, in some embodiments, some or all of the sensor data is received from the user's vehicle itself, either via the user device 103 or directly from the vehicle to the server 102. In these embodiments, the sensor data may be from the vehicle that the user is using during the trip or the sensor data may come from the user's baseline vehicle to confirm that the user did not use their baseline vehicle during that trip.

If the sensor data corresponds to the stored sensor data for that mode of transport, the mode of transport is verified (“yes” branch at block 412) and the method 400 may proceed to block 414 If the sensor data does not correspond with the stored sensor data for that mode of transport, the mode of transport is not verified (“no” branch at block 412) and the method 400 ends and no emission savings value is determined.

Alternatively, if the mode of transport is not verified, the server 102 may identify an actual mode of transport based on the stored sensor data that corresponds to the sensor data from the user device 103. In these embodiments, the actual mode of transport may be used to determine the emission savings value at block 414. In some embodiments, verifying the mode of transport further comprises verifying that the mode of transport is indeed a lower emission mode of transport than the baseline mode of transport. For example, the server 102 may compare an emission profile for the mode of transport in the emission data source 108 to the emission profile for the baseline mode of transport to determine if the mode of transport is a lower emission mode of transport than the baseline. If it is a lower emission mode of transport, the method 400 may proceed to block 414. If it is not a lower emission mode of transport, the method 400 may end without determining the emission savings value. If it is not a lower emission mode of transport, the method 400 may also end because there was no net emission savings value. This step may be performed before or after verifying the mode of transport using the sensor data.

In the example method 400 in FIG. 4, the mode of transport is verified after the trip distance is determined; however, in other embodiments, the mode of transport may be verified before the trip distance is determined or at substantially the same time.

At block 414, upon successful verification of the mode of transport, the server 102 determines the emission savings value for the trip. The emission savings value may be determined by determining an emission estimate for the trip and then calculating the difference between the trip emission estimate and a baseline emission estimate for the baseline mode of transport. In some embodiments, the baseline mode of transport is the baseline mode of transport identified by the user in the verification request (e.g., the user's primary vehicle). In other embodiments, the baseline mode of transport is the baseline mode of transport stored by the server 102 as part of the user's profile. In alternative embodiments, the user consumption baseline may be used instead of the baseline emission estimate.

The server 102 may determine the emission estimate for the trip based on the integral of the fuel consumption profile function for the trip in the verified mode of transport. Determining the function relies on active inputs from the user device 103. The most basic fuel consumption function over time would be the direct multiplication of distance and the mileage of the mode of transport. However, the verified mode of transport is a dynamic system, therefore, the trip fuel consumption profile may be represented in a non-linear function. Verifying the fuel consumption function utilizes comparisons to known curves stored in the emissions data source 108. Trip emissions may be calculated from the integral of the trip fuel consumption function multiplied by carbon dioxide equivalent emissions for the combustion of that type of fuel. The server 102 may also determine the baseline emission estimate by modifying the verified trip fuel consumption function using published data on the difference in mileage between the verified mode of transport and the baseline mode of transport stored in the emissions data source 108. The emissions savings value is the result of the subtraction of the trip emissions estimate from the baseline emissions estimate. For greater clarity, it will be understood that determining the trip emissions estimate and the baseline emissions estimate is complex and relies on more than just the mileage data for given modes of transport but also includes carbon lifecycle analysis and active monitoring of data. For example, the determination of the emissions estimates may account for whether the trip involved highway travel or city travel, which can alter engine efficiency and other factors like the number of stops. This determination may also include other complex factors such as temperature, moisture, altitude, weather, seasons, etc.

The emission savings value may be expressed as tonnes (tons) of carbon dioxide or in any other suitable unit. The emissions saving value calculation may result in a zero or negative number in some instances, in which case no emission savings are granted for the trip. In another embodiment, a negative emission savings value may result in a penalty levied on the user.

In some embodiments, the server 102 may compare the determined emission savings value with a localized average of emission savings values for the same geographical area, or based on the user's occupation, using data in the emission data source 108. If the determined emission savings value significantly differs from the localized average (for example, if it is significantly higher), the server 102 may deny the user any emissions savings and/or send the determined emission savings value to the emission data source 108 to be incorporated into the localized average and thereby improve the quality of the data.

In some embodiments, the method 400 further comprises issuing the emission savings value to the user. In some embodiments, the emission savings value is issued by transmitting the emission savings value to a user account, digital wallet, etc., where it may be stored until the user wishes to convert, redeem, or otherwise use the emission savings value in a carbon marketplace. The emission savings value may also be stored in the user account as a token. Tokenization may replace the emission savings value with tradeable tokens such as carbon credits, carbon offsets, or a token representing a discrete amount of carbon dioxide emissions reductions. etc. In some embodiments, tokenization is performed by the system 100. In other embodiments, the server 102 may transmit the emission savings value to an independent system for tokenization and the independent system may issue carbon credits, carbon offsets, etc. to the user.

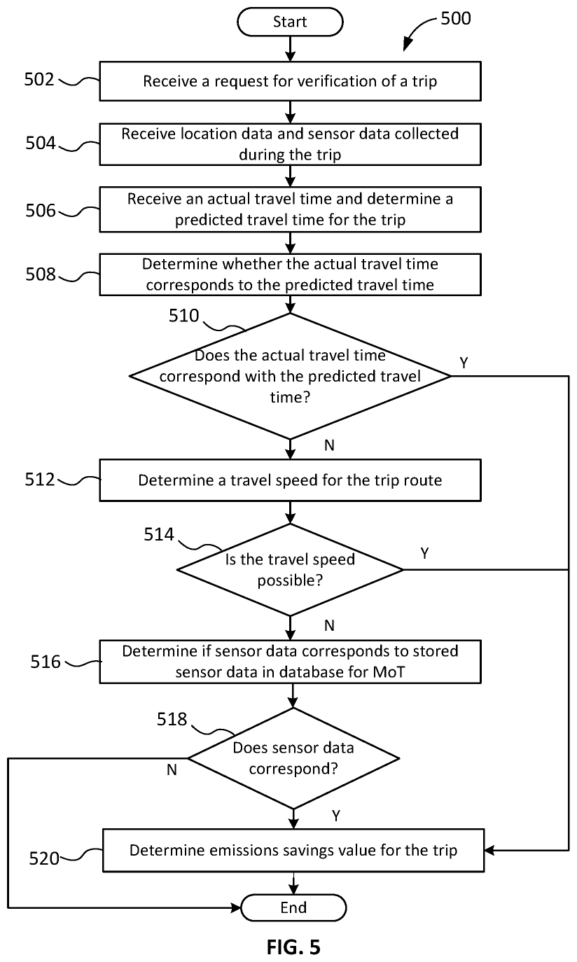

FIG. 5 is a flowchart of an example method 500 with additional steps for verifying a mode of transport.

At block 502, the server 102 receives a request for verification of a trip from the user device 103 via the communication network 105. The request may include a mode of transport. The steps at block 502 may be similar to the steps at block 402 of the method 400 of FIG. 4 as described above.

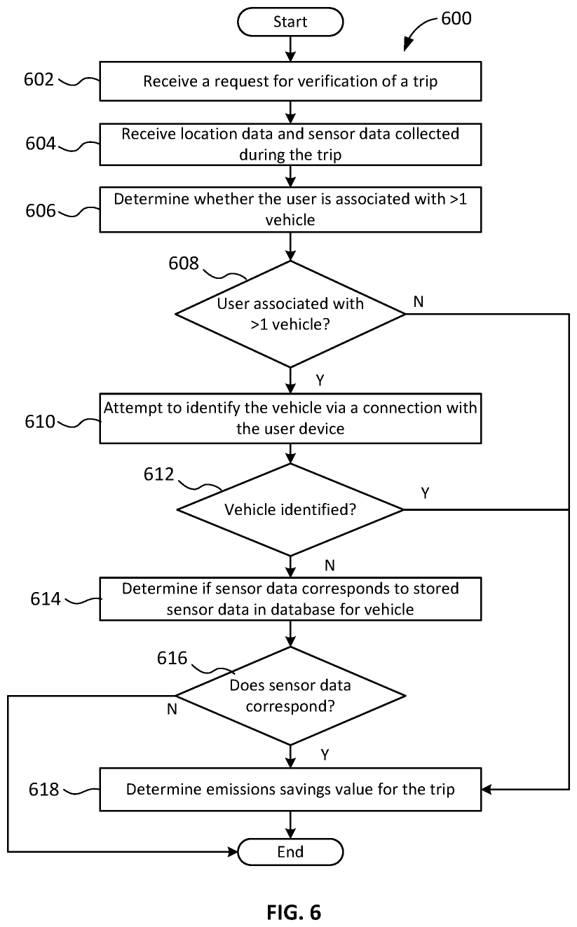

In this example, the mode of transport identified in the verification request is a zero-combustion-emissions mode of transport such as walking or biking. In some embodiments, the server 102 identifies whether the user-indicated mode of transport is a zero-combustion-emissions mode of transport before proceeding with the rest of the method 500. The method 500 may be used for zero-combustion-emissions modes of transport with average travels speeds below about 30 km/hr. If the mode of transport is a vehicle or another mode of transport that generates combustion emissions, the server 102 may utilize the method 600 of FIG. 6 to verify the mode of transport instead of the method 500.

At block 504, the server 102 receives location data and sensor data from the user device 103 via the communication network 105. The steps at block 504 may be similar to the steps at blocks 404 and 406 of the method 400. In some embodiments, the trip distance may be determined in a similar manner to block 408 of the method 400.

At block 506, the server 102 receives an actual travel time and determines a predicted travel time for the trip using the mode of transport. The actual travel time may be received from the user device 103, for example, using time stamps from the start point and end point of the trip. The predicted travel time may be determined using the mapping data source 106, for example, using a mapping software application. The predicted travel time may instead use an average travel speed for the mode of transport. The average travel speed may be based on historical data, which may be stored in the mapping data source 106 and/or the emission data source 108.

At block 508, the server 102 determines whether the actual travel time corresponds to the predicted travel time. In some embodiments, the server 102 determines whether the actual travel time is within a selected range of the predicted travel time, for example, within about ±5%, about ±10%, or about ±20%. The range may be selected to account for localized impacts on trip duration such as traffic, road conditions, etc. If the mode of transport is non-motorized (e.g., walking, biking), the selected range may be larger than a motorized mode of transport, due to an expected wider variation in human abilities and behavior.

If the actual travel time corresponds to the predicted travel time (“yes” branch at block 510), the mode of transport is verified and the method 500 proceeds to block 520 to determine the emission savings value. If the actual travel time does not correspond to the predicted travel time (“no” branch at block 510), the mode of transport is not yet verified and the method 500 proceeds to block 512.

At block 512, the server 102 determines a travel speed based on the actual travel time and the trip distance. The server 102 may then determine whether the travel speed is possible (or realistic) for the mode of transport. The travel speed used for this determination may be the average travel speed for the entire trip and/or the minimum and maximum speed used during the trip. In some embodiments, the server 102 may compare the travel speed with an average travel speed for that mode of transport stored in the mapping data source 106 and/or the emission data source 108. The server 102 may determine if the travel speed is slower or faster than the average travel speed.

If the travel speed is slower than the average travel speed, the travel speed may still be possible for some non-motorized modes of transport. For example, an individual with mobility issues or walking with a small child may have a much lower walking speed than the average individual. Road or sidewalk conditions may also affect individuals on bicycles or scooters.

If the travel speed is faster than the average travel speed, the server 102 may determine if the travel speed is within a selected margin of the average such as within about 5%, about 10%, or about 20%. The margin may be selected based on the maximum speed a human (or animal) may reasonably be able to achieve for that mode of transport. A travel speed outside of the selected margin may therefore indicate that the user entered an incorrect or false mode of transport in their verification request (e.g., the user may be driving a vehicle instead of walking or biking).

If the travel speed is possible (“yes” branch at block 514), the mode of transport is verified and the method 500 proceeds to block 520 to determine the emission savings value. If the travel speed is not possible (“no” branch at block 514), the mode of transport is not yet verified and the method 500 proceeds to block 516.

At block 516, the server 102 determines whether the sensor data from the user device 103 corresponds to stored sensor data in the sensor data source 104 for that mode of transport. The steps at block 516 may be similar to the steps of block 410 of the method 400 as described above. For example, the server 102 may determine whether accelerometer data from the user device 103 with stored accelerometer data in the sensor data source 104, which may indicate if the user was walking or biking vs. using a vehicle.

If the sensor data corresponds to the stored sensor data (“yes” branch at block 518), the mode of transport is verified and the method 500 proceeds to block 520 to determine the emission savings value. If the sensor data does not correspond to the stored sensor data (“no” branch at block 518), the mode of transport is not verified and the method 500 ends. If the method 500 ends without verifying the mode of transport, the server 102 may send a notification to the user device indicating that the trip has not been verified and no emission savings value will be issued. In some embodiments, the user may be prompted, via the user interface 132, to enter updated information and the method 400 may return to block 412 to re-attempt to verify the mode of transport.

At block 520, the emissions savings value is determined for the trip. The steps at block 520 may be similar to the steps at block 414 of the method 400. The emission savings value may then be issued to the user.

Other variations are also possible. In other embodiments, the steps at blocks 512 and 514 are omitted and the method 500 proceeds directly from block 510 to block 516 if the actual travel time does not correspond with the predicted travel time. In yet other embodiments, the steps at block 516 may be used as a secondary verification even if the actual travel time corresponds with the predicted travel time (“yes” branch at block 510) and/or if the travel time is possible (“yes” branch at block 514).

FIG. 6 is a flowchart of another example method 600 with additional steps for verification of a mode of transport.

At block 602, the server 102 receives a request for verification of a trip from the user device 103 via the communication network 105. The request may include a mode of transport. The steps at block 602 may be similar to the steps at block 402 of the method 400 of FIG. 4 as described above.

In this example, the mode of transport identified in the verification request is a vehicle. In some embodiments, the method 600 further comprises confirming that the mode of transport is a vehicle by determining a predicted travel time for the trip and determining if the actual travel time corresponds to the predicted travel time, similar to the steps of blocks 506 and 508 of the method 500 of FIG. 5. In some embodiments, the method 600 further comprises determining a travel speed and determining if the travel speed is possible, similar to the steps of blocks 512 and 514 of the method 500.

At block 604, the server 102 receives location data and sensor data from the user device 103 via the communication network 105. The steps at block 604 may be similar to the steps at blocks 404 and 406 of the method 400. In some embodiments, the trip distance may be determined in a similar manner to block 408 of the method 400.

At block 606, the server 102 determines whether the user is associated with more than one vehicle. In some embodiments, the server 102 may access stored profile information for the user identifying any vehicles associated with the user. In other embodiments, the server 102 may retrieve data from the vehicle data source 110 and/or the insurance data source 112 identifying any vehicles associated with the user.

If the user is associated with more than one vehicle (“yes” branch at block 608), the method 600 proceeds to block 610. If the user is not associated with more than one vehicle (“no” branch at block 606), then the method 600 proceeds to block 618 to determine the emissions savings value for the trip.

At block 610, the server 102 attempts to identify the vehicle via a connection between the vehicle and the user device 103. For example, the vehicle may connect to the user device 103 or the user device 103 may connect to the vehicle via a Bluetooth connection. The initial connection of the user device 103 to the vehicle may require a multi-step approval process to establish a recurring proximity link commonly referred to as ‘pairing’. The connection between the vehicle and the user device 103 may also be made through an intermediate device, or multiple intermediate devices, relaying the connection. Alternatively, the connection may be made through other wireless methods or directly through a wired connection to the vehicle. When a connection is detected by the user device 103 it will send a request for data to the vehicle's onboard computer. The information sent from the vehicle back to the user device 103 may include vehicle identification information and data from the vehicle sensors. The information passed to the user device may originate from the vehicle's onboard computer or be relayed from external sources via the vehicle's onboard computer. The server 102 may receive an indication of this connection from the user device 103 where the information is relayed through communication network 105.

If the vehicle is identified (“yes” branch at block 612), then the method 600 proceeds to block 618 to determine the emissions savings value for the trip. If the vehicle is not identified (“no” branch at block 612), then the method proceeds to block 614. For example, the vehicle may not support device connectivity, or the user device 103 may have its Bluetooth connectivity turned off, which may prevent identification of the vehicle at this step.

At block 614, the server 102 determines whether the sensor data from the user device 103 and/or the vehicle sensor data corresponds to stored sensor data in the sensor data source 104 for the vehicle. For example, the server 102 may compare one or more photos/videos taken during the trip with stored photos/videos of vehicle interiors. As another example, the server 102 may compare sound signature data from the trip with stored sound signature data for different types of vehicles, or the accelerometer data matching acceleration profiles for specific types of transportation. In some embodiments, the server 102 is able to use the sensor data to verify the exact make and model of the vehicle. In other embodiments, the server 102 only verifies the type of vehicle (e.g., combustion engine vs. electric vs. hybrid) based on the sensor data.

If the sensor data corresponds to the stored sensor data (“yes” branch at block 616), the mode of transport is verified and the method 600 proceeds to block 618 to determine the emission savings value. If the sensor data does not correspond to the stored sensor data (“no” branch at block 616), the mode of transport is not verified and the method 600 ends. If the method 600 ends without verifying the mode of transport, the server 102 may send a notification to the user device indicating that the trip has not been verified and no emission savings value will be issued.

At block 618, the emissions savings value is determined for the trip. If the user only owns one vehicle, and that vehicle used during the trip is the same as the baseline vehicle, then the emissions savings value will be determined to be zero. If the user owns more than one vehicle, and the vehicle used during the trip generates lower emissions than the baseline vehicle (e.g., if the trip vehicle is electric or hybrid and the baseline vehicle is a combustion engine vehicle), then the emissions savings value may be determined using emission profiles for the trip vehicle and the baseline vehicle. The steps at block 618 may otherwise be similar to the steps at block 414 of the method 400. The emission savings value may then be issued to the user.

Therefore, by determining the trip distance using location data and verifying the mode of transport prior to determining the emission savings value, the methods 400, 500, and 600 reduce the risk of emission savings values being issued to a user who has attempted to “cheat” by entering a false mode of transport or a more circuitous trip route to increase their emission savings value. In addition, methods 400, 500, and 600 may allow the server 102 to use less processing power (fewer operations) transferring computation from the GPU to the CPU and thereby reduce power consumption compared to other methods as emission savings values are only determined for verified trips methods as emission savings values are only determined for verified trips, not all trips. Moreover, by determining emission savings values only for verified trips, the determined emission savings values are also more accurate, and thus the data being fed into the emissions data source 108 is also more accurate, which improves the quality of the analysis. Data quality and accuracy in terms of verifying or identifying the user's mode of transport may also be improved through orchestration of multiple sensors of the user device 103. Therefore, if certain sensors are faulty, they can be ruled out using data from other sensors. By using orchestration to record data from multiple (or all) sensors at the same time, the user device 103 may also use less battery power.

FIG. 7 is a flowchart of an example method 700 for verifying a baseline mode of transport, according to some embodiments. The method 700 may be performed prior to the methods 400, 500, and 600 or in parallel.

At block 702, the server 102 receives user input from the user device 103, via the communication network 105, identifying a baseline vehicle. The user input may include a vehicle identification number (VIN) for that vehicle. The term “vehicle identification number” or “VIN” in this context refers to a number, or combination of numbers and letters, used by vehicle manufacturers to identify each vehicle. Different vehicles may have different VIN systems. The user input may also include an insurance policy number associated with the baseline vehicle. In some embodiments, the user input also includes an odometer reading and a fuel level reading from both the start and the end of a trip. In other embodiments, the user input may comprise any other relevant information related to their vehicle. The user may input the information into the mobile application installed on the device 103 via the user interface 132. In some embodiments, the user input is included in the trip verification request in the method 400, 500, or 600. In other embodiments, the user input is received separately before or after a trip.

In some embodiments, the server 102 also receives sensor data from the user's vehicle (either directly from the vehicle itself or via the user device 103). The sensor data may include fuel level readings from the fuel tank sensors, trip mileage, distance, etc.

At block 704, the server 102 determines if the vehicle is registered to the user. The server 102 may determine whether the used input VIN corresponds to a stored VIN associated with the user. In some embodiments, the stored VIN is in a vehicle registration database of the vehicle data source 110. In other embodiments, the stored VIN is in a vehicle registration database of an external vehicle registry. The external vehicle registry may be, for example, a private or government registry for the city, state, province, or country in which the user resides. In some embodiments, the server 102 transmits a request to the external vehicle registry via the communication network 105, the request indicating the name of the user and/or the VIN and requesting confirmation of registration. The server 102 may then receive a response from the registry indicating whether the vehicle is registered to the user. For example, the request may indicate the VIN and the response may indicate the name of the owner that vehicle, or the request may indicate the user's name and the response may indicate the VIN associated with that name.

If the vehicle is registered to the user (“yes” branch at block 706), the method 700 proceeds to block 708. If the vehicle is not registered to the user (“no” branch at block 706), the method 700 ends and the baseline vehicle is not verified. If the method 700 ends, the server 102 may send a notification to the user device 103, via the user interface 132, informing the user that the baseline vehicle is not verified. In some embodiments, the user is then prompted to enter updated information for their baseline vehicle and the method restarts at block 702.

At block 708, the server 102 determines if the vehicle is covered by an active insurance policy for at least part of the trip. In some embodiments, the server 102 determines whether the insurance policy number provided by the user corresponds with a stored active insurance policy number associated with the vehicle (and/or the user). In some embodiments, the stored active insurance policy number is in an insurance policy database in the insurance data source 112. In other embodiments, the stored active insurance policy number is in an insurance policy database of an external insurance provided. The external insurance provider may be, for example, an insurance agency or broker. In some embodiments, the server 102 transmits a request to the external insurance provider via the communication network 105, the request indicating at least one of the user name, VIN, and the insurance policy number and requesting confirmation of an active insurance policy. In some embodiments, the server 102 may send requests to multiple insurance providers. The server 102 may then receive a response from one of the providers indicating that the vehicle is covered by an active insurance policy. If the vehicle was covered by a policy for only part of the trip, the response may indicate the start and end dates of the policy. If the request only indicated the user name and/or VIN, the response may also include the insurance policy number. If the request only indicated the user name and/or the insurance policy number, the response may include the VIN of the vehicle that is associated with the insurance policy. In embodiments in which the VIN is received from the insurance provider, the registration of the user's vehicle can thereby be confirmed at block 708 and the steps of block 704 can optionally be omitted.

Alternatively, or additionally, the user may be prompted to upload a picture of their active insurance policy, showing the effective date and date of expiry, via the mobile application on the user device 103. The server 102 may the compare the date of the trip with the effective date and the date of expiry to confirm that the vehicle was covered by an active policy for at least part of the trip.

If the vehicle is covered by an active insurance policy for at least part of the trip (“yes” branch at block 710), the method 700 proceeds to block 712. If the vehicle is not covered by an active insurance policy for any part of the trip (“no” branch at block 710), the method 700 ends and the baseline vehicle is not verified.

At block 712, the server 102 determines if the vehicle is reasonable for a given geographical area. The geographical area may be the area in which the user resides and/or works or may be the area in which a given trip takes place. The server 102 may provide a per vehicle normalized average emissions reduction for the given geographic area (e.g., stored in the emission data source 108). As one example, the average emissions reduction may be normalized based on vehicle engine size. The normalized average emissions reduction may be compared to the emissions reduction claimed by the user for the trip to determine if the user's baseline vehicle is reasonable. For example, the server 102 may determine if the emissions reduction claimed by the user is within a selected margin of the normalized average, such as within 5%, 10%, 20%, etc. Alternatively, a per vehicle normalized range of emissions reductions may be provided and the server 102 may determine if the user-claimed emissions reduction is higher or lower than the maximum of the range. For example, if the user is in a metropolitan area, using tractor as their baseline vehicle would result in an emissions reduction outside of the selected margin of the normalized average or higher than the maximum of the range. Similarly, using a semi-trailer truck as a baseline vehicle in a residential area would result in an “unreasonable” emissions reduction claim.

If the user-claimed emissions reduction is within the selected margin, or lower than the maximum of the range, then the vehicle is reasonable for that geographical area (“yes” branch at block 714), and the vehicle is now verified and the method 700 proceeds to block 716. If the user-claimed emissions reduction is outside of the selected margin, or higher than the maximum of the range, the vehicle is not reasonable (not at block 714), the method 700 ends and the baseline vehicle is not verified.

In some embodiments, if the vehicle is not reasonable, the server 102 may check if the vehicle type is unique with respect to saved vehicle types for that geographical area (e.g., in the emission data source 108 and/or the vehicle data source 110). If the vehicle is unique, then the server 102 may transmit a request to the user device 103 requiring the user to enter a new baseline vehicle. If the vehicle is not unique, then the normalized average emissions reduction may be used in place of the user claimed emission reduction to determine the emission savings value at block 716 below.

At block 716, the verified baseline vehicle is used to determine an emission savings value, such as at blocks 414, 520, or 618 of the method 400, 500, or 600, respectively. If the baseline vehicle was only covered by an active insurance policy for part of the trip, that factor may be included in determining the emission savings value, for example, by only issuing the emission savings value for the part of the trip during which the insurance policy was active.

In some embodiments, the verified baseline vehicle is saved in a user profile such that the vehicle does not need to be verified for every trip. In some embodiments, the baseline vehicle is saved for a set period of time before the user is requested to re-verify their vehicle. In other embodiments, the baseline vehicle is verified for every trip.

In some embodiments, the method 700 further comprises determining the fuel efficiency of the baseline vehicle. For example, the server 102 may calculate an average mileage for a trip using the odometer readings and fuel level readings from the start point and end point of the trip. In some embodiments, the fuel efficiency of the vehicle may be verified using the user's fuel purchase history obtained from a linked bank account.

In some embodiments, the method 700 further comprises determining a user consumption baseline for the user. In some embodiments, the server 102 determines the user consumption baseline using fuel purchase history from the user's bank account, credit card account, etc. In some embodiments, the user may be prompted to upload photographs of fuel purchase receipts via the mobile application to supplement the bank account information (e.g., for cash purchases).

In other embodiments, the user consumption baseline may be based on fuel sensor readings, trip mileage, etc. tracked over a period of time. In another embodiment, the user may be prompted to upload an image of their vehicle bill of sale, insurance policy, etc. that shows the odometer reading at the time the vehicle was first purchased/insured. Alternatively, the server 102 may request this information from an external data source. The user may then be prompted to upload a photo of the current odometer reading on their vehicle. The server 102 may then determine the user consumption baseline based on the difference between the two readings, taking into account the period of time between when the vehicle was first purchased/insured and the time stamp of the photograph of the current odometer reading.

Other variations are also possible. In other embodiments, the order of the steps may be modified such that the server 102 determines if the baseline vehicle is reasonable first before checking the VIN and insurance policy. In yet other embodiments, only the VIN and/or the insurance policy may be used to verify the baseline vehicle and the other steps may be omitted.

Therefore, embodiments of the method 700 may reduce the risk of an emission savings value being issued to a user who has attempted to “cheat” by inputting a false baseline vehicle with higher emissions than their actual primary vehicle. In addition, by verifying the baseline vehicle prior to the methods 400/500/600, the server 102 uses less processing power (fewer instructions) than conventional methods as only trips with a verified baseline vehicle are then verified and used to determine emission savings values. Using a verified baseline vehicle also improves the accuracy of the emission savings value determination.

FIG. 8 is a flowchart of an example method 800 with additional steps for determining the emission savings value, according to some embodiments. The method 800 may be performed following the methods 400, 500, and/or 600 or in parallel.

At block 802, the server 102 determines the shortest reasonable distance for the trip. In this context the “shortest reasonable distance” refers to shortest distance between the start location and the end location of the trip, using appropriate roads, sidewalks, pathways, etc. based on the mode of transport. The shortest reasonable distance may be determined using the mapping data source 106.

At block 804, the server 102 determines if the trip distance corresponds with the shortest reasonable distance. In this embodiment, the trip distance is the actual distance traveled by the user, as determined above in the method 400. The server 102 may determine if the trip distance is longer or shorter than the shortest reasonable distance. If the trip distance is longer than the shortest reasonable distance, the server 102 may determine if the trip distance is within a selected margin, such as within 5%, 10%, or 20%. A longer distance that is still within the selected margin may indicate a disruption or detour, such as construction or a traffic accident. But a significantly longer distance that is outside of the margin may indicate that the user used a more circuitous route to increase their emission savings value. For example, the user may have circled the area around their home or workplace to artificially inflate their emission savings value.

If the trip distance corresponds with the shortest reasonable distance within the selected margin (“yes” branch at block 806), the method 800 proceeds to block 808. At block 808, the trip distance (i.e., the actual distance travelled by the user) is used in the determination of the emission savings value, such as at blocks 414, 520, or 618 of the method 400, 500, or 600, respectively.

If the trip distance does not correspond with the shortest reasonable distance within the selected margin (“no” branch at block 806), the method 800 proceeds to block 810. At block 810, the shortest reasonable distance is used in the determination of the emission savings value.

Thus, the method 800 may improve the accuracy of the emission savings value determination by ensuring that the user cannot use a more circuitous or exaggerated route to artificially inflate their emission savings.

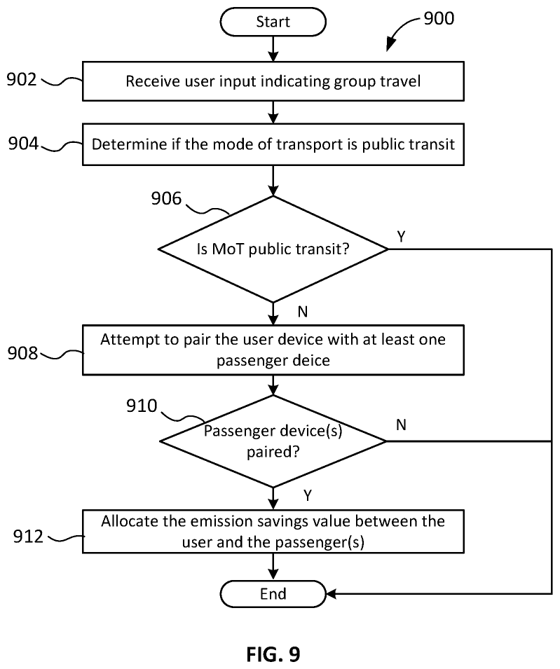

FIG. 9 is a flowchart of an example method 900 with additional steps for verifying a group travel trip. The method 900 may be performed in parallel with the methods 400, 500, and/or 600.

At block 902, the server 102 receives user input, via the user device 103, indicating that the trip is a group travel trip. In this context, “group travel trip” refers to a trip in which more than one passenger is using the same mode of transport for at least part of the trip. For example, the group travel trip may involve carpooling or ride sharing. The user may input the information in the mobile application installed on their device 103 via the user interface 132. In some embodiments, the user input is included in the trip verification request in the method 400, 500, or 600. In other embodiments, the user input is received separately.

At block 904, the server 102 determines if the mode of transport is a form of public transit. Public transit may include a public bus, train, subway, etc. In some embodiments, the determination is made based on user input. In other embodiments, the mode of transport is determined by comparing sensor data from the user device 103 with stored sensor data in the sensor data source 104, in a similar manner to block 412 of the method 400.

If the mode of transport is public transit (“yes” branch at block 906), the method 900 ends. When the emissions savings value is determined for the trip in method 400, 500, or 600, the server 102 will use an appropriate emission profile for that form of public transit. The determination of emission saving values for public transit may use different calculations and factors than travel in a private vehicle.

If the mode of transport is not public transit (“no” branch at block 906), the method 900 proceeds to block 908. At block 808, the server 102 attempts to pair the user device 103 with at least one passenger device. The server 102 may first request user input, via the user device 103, as to the identity of the other passenger(s) in the vehicle. The server 102 may then receive a response indicating the other passenger's name, mobile phone number, and/or any other identifying information. The server 102 may determine if the other passenger(s) have previously submitted trip verification requests and thus have the mobile application installed on their device. If so, the server 102 may transmit a request to the passenger device to pair the passenger device with the user device 103 (or vice versa). If not, the server 102 may transmit a message to the passenger device, via their mobile phone number or any other suitable communication means, instructing the passenger to install the mobile application on their device. The server 102 may then again attempt to pair the user device 103 with the passenger device. If there are multiple passengers in the same vehicle, this step may be repeated for each additional passenger.

If the server 102 is successfully able to pair the user device 103 to at least one passenger device (“yes” branch at block 910), the method 900 proceeds to block 912. At block 912, the emissions savings value is allocated between the user and each passenger with a paired device. In some embodiments, once the trip is verified using the methods 400, 500, and/or 600, the entire emissions estimate for the trip is equally divided between the driver and the passengers. For example, if there are four people in a car (e.g., the driver and three passengers), ¼ of the emissions estimate is allocated to each person. The emissions estimate for a given individual is then subtracted from a baseline emissions estimate for that individual's baseline vehicle (using the steps described above for block 414 of the method 400) to determine the emissions savings value for that individual.

If the user device 103 and the passenger device are paired for the entire trip, then both the user and the passenger may be issued emission savings values for the full trip distance. If the user device and the passenger device are paired for only part of the trip, the user and the passenger may only be issued emission savings values for the portion of the trip distance in which their devices were paired to one another. Alternatively, if the user device and the passenger device are paired for only part of the trip, then the user may still be issued the emission savings value for the full trip distance but the passenger may only be issued the emission savings value for the part of the trip distance during which their device was paired. If the passenger joins later in the trip or exits earlier than the driver (e.g., if the passenger is picked up after the start point of the trip or dropped off before the end point), the passenger may earn an emission savings value greater than that of the driver because they would not be in the vehicle when there was only one individual in the vehicle (i.e., the driver).

If the server 102 is not able to pair the user device 103 with any passenger devices (“no” branch at block 910), then the method 900 ends. When the emissions savings value is determined for the trip in method 400, 500, or 600, the server 102 will not apply any group travel factors and will determine the emission savings value as if the user took the trip alone (i.e., a single occupancy trip).

Therefore, the method 900 may allow multiple passengers to claim emission savings values for the same trip. The method 900 may also increase processing efficiency of the server 102 as the same trip emissions estimate can be divided between the user and passenger(s) rather than calculating individual trip emissions estimates for each passenger.

Although particular embodiments have been shown and described, it will be appreciated by those skilled in the art that various changes and modifications might be made without departing from the scope of the disclosure. The terms and expressions used in the preceding specification have been used herein as terms of description and not of limitation, and there is no intention in the use of such terms and expressions of excluding equivalents of the features shown and described or portions thereof. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A computer-implemented method comprising:
receiving, from a user device:
a request for verification of a trip, the request indicating a mode of transport;
location data collected during the trip; and
sensor data collected by at least one sensor during the trip;
determining a trip distance using the location data;
attempting to verify the mode of transport by determining whether the sensor data corresponds to stored sensor data for the mode of transport in a database; and
upon successful verification of the mode of transport, determining an emission savings value for the trip.

2. The method of claim 1, wherein the sensor data comprises at least one of:
photographic data, video data, accelerometer data, vibration data, sound signature data, and altitude data.

3. The method of claim 1, wherein the location data comprises at least one of GPS logs, cell phone pings and cell tower triangulation, cell signal strength data, mapping software data, and compass data.

4. The method of claim 1, wherein determining the trip distance comprises determining displacement of the user between a start location and an end location using location data from a start point and an end point of the trip.

5. The method of claim 1, wherein attempting to verify the mode of transport further comprises:
determining a predicted travel time for the trip based on historical data for the mode of transport;
receiving an actual travel time for the trip from the user device; and
determining whether the actual travel time corresponds to the predicted travel time.

6. The method of claim 5, wherein attempting to verify the mode of transport further comprises:
determining a travel speed based on the actual travel time and the trip distance; and
determining whether the travel speed is possible for the mode of transport.

7. The method of claim 1, wherein attempting to verify the mode of transport further comprises identifying a vehicle via a connection between the vehicle and the user device.

8. The method of claim 1, wherein determining the trip distance comprises determining an actual distance travelled by the user using the location data from various points during the trip.

9. The method of claim 8, further comprising:
determining a shortest reasonable distance for the trip using a mapping data source;
determining whether the actual distance is longer than the shortest reasonable distance; and
upon determining that the actual distance is longer than the shortest reasonable distance, using the shortest reasonable distance to determine the emission savings value for the trip.

10. The method of claim 1, wherein determining the emission savings value for the trip comprises determining a difference between an emission estimate for the trip and a baseline emission estimate for a baseline mode of transport.

11. The method of claim 10, further comprising attempting to verify the baseline mode of transport.

12. The method of claim 11, wherein the baseline mode of transport is a vehicle and wherein attempting to verify the baseline mode of transport comprises at least one of:
determining if the vehicle is registered to the user; and
determining if the vehicle is covered by an active insurance policy for at least part of the trip.

13. The method of claim 12, wherein attempting to verify the baseline mode of transport further comprises comparing an emissions reduction claimed by the user with a per vehicle normalized average emissions reduction for a geographical area.

14. The method of claim 1, further comprising:
receiving, from the user device, user input indicating at least one additional passenger using the same mode of transport;
attempting to pair the user device with at least one passenger device; and
upon successful pairing, allocating the emission savings value between the user and the at least one additional passenger.

15. A computer-implemented method comprising:
receiving, from a user device, user input identifying a baseline vehicle, the user input including at least one of a user name, a vehicle identification number (VIN), and an insurance policy number;
attempting to verify the baseline vehicle by at least one of:
determining if the VIN corresponds with a stored VIN associated with the user in a vehicle registration database;
transmitting a request for confirmation of registration to an external vehicle registry, the request for confirmation indicating at least one of the user name and the VIN;
determining if the insurance policy number corresponds with a stored active insurance policy number associated with the user in an insurance policy database; and
transmitting a request for confirmation of an active insurance policy to an external insurance provider, the request indicating at least one of the user name, the VIN, and the insurance policy number;
upon successful verification of the baseline vehicle, receiving, from the user device a request for verification of a trip, the request for verification indicating a mode of transport; and
determining an emission savings value based on a difference in estimated emissions between the mode of transport and the baseline vehicle for the trip.

16. The method of claim 15, wherein attempting to verify the baseline vehicle comprises transmitting the request for confirmation of the active insurance policy to the external insurance provider, and further comprises receiving a response from the external insurance provider, the response including the VIN of the baseline vehicle.

17. The method of claim 15, further comprising comparing an emissions reduction claimed by the user with a per vehicle normalized average emissions reduction for a geographical area.

18. The method of claim 15, further comprising:
receiving, from the user device, location data collected during the trip; and
determining a trip distance using the location data.

19. The method of claim 15, further comprising:
receiving, from the user device, sensor data collected by at least one sensor during the trip; and
attempting to verify the mode of transport by determining whether the sensor data corresponds to stored sensor data for the mode of transport in a database.

20. The method of claim 15, further comprising:
receiving, from the user device, user input indicating at least one additional passenger using the same mode of transport;
attempting to pair the user device with at least one passenger device; and
upon successful pairing, allocating the emission savings value between the user and the at least one additional passenger.
